(19) United States
(12) Patent Application Publication
(10) Pub. No.: US 2012/0268588 A1
(43) Pub. Date: Oct. 25, 2012

(54) METHOD AND SYSTEM FOR DETERMINING OPTICAL PROPERTIES OF A LENS SYSTEM

(75) Inventors: Klaus Eckerl, Hutthurm (DE); Norbert Harendt, Regensburg (DE)

(73) Assignees: CHROSZIEL GMBH, Heimstetten (DE); IB/E OPTICS ECKERL GMBH, Hutthurm (DE)

(21) Appl. No.: 13/082,177

(22) Filed: Apr. 7, 2011

Related U.S. Application Data
(60) Provisional application No. 61/322,180, filed on Apr. 8, 2010.

(30) Foreign Application Priority Data
Apr. 8, 2010 (DE) 10 2010 014 215.8

(51) Int. Cl. H04N 7/18

(52) U.S. Cl. 348/135; 348/E07.085

(57) ABSTRACT

A system for determining at least one optical property of a lens system, comprising: a position sensitive detector 25 for generating image data representing an image projected onto the detector, and a controller 41 configured to receive the image data, to perform a first analysis of the image data in order to determine an identifier of a partial pattern contained in the image represented by the image data, to perform a second analysis of the image data in order to determine at least one property based on the image of the partial pattern, and to generate data representing the at least one optical property of the lens system associated with an image position of the image based on the determined at least one property.

### CROSS-REFERENCES TO RELATED APPLICATIONS

The present application claims priority of German Patent Application No. 10 2010 014 215.8 filed on Apr. 8, 2010 entitled “METHOD AND SYSTEM FOR DETERMINE OPTICAL PROPERTIES OF A LENS SYSTEM” and of U.S. provisional application 61/322,180 filed Apr. 8, 2010 entitled “METHOD AND SYSTEM FOR DETERMINE OPTICAL PROPERTIES OF A LENS SYSTEM”, the contents of both applications are hereby incorporated by reference in their entirety.

### FIELD

The present disclosure relates to methods of determining at least one optical property of a lens system and to systems for determining at least one optical property of a lens system.

### BACKGROUND

Lens systems designed for a certain purpose, such as lens systems used as an objective lens of a still picture camera or a movie camera and as projection lenses of a film projector, are available in a large number of different types, and new types are continuously developed. The types differ not only with respect to price but also with respect to their optical imaging qualities. In order to compare different types of lens systems, it is necessary to determine their optical properties. There exist plural concepts of characterizing optical properties of lens systems. One concept is based on the point spread function and uses so-called point images which can be determined at different positions within the image field of the lens system. A further concept is based on the modulation transfer function (MTF) and uses the so-called modulation transfer which can also be determined for different locations within the image field of the lens system. Other concepts of determining the optical properties of a lens system are possible.

According to a conventional method of determining the optical properties of an objective lens for a still picture camera, the objective lens is positioned in a measuring system comprising a light source, a test pattern and a screen. The test pattern is illuminated with light generated by the light source and projected onto the screen by the objective lens. The test pattern comprises a plurality of partial patterns located adjacent to each other. The partial patterns are structured and provide light and dark line pairs having different widths and different orientations, for example. The partial patterns projected onto the screen are visually inspected by a person in order to determine an optical property of the lens, such as, for example, a cut-off frequency of line pairs which can be transferred with the objective lens. Using the plural partial patterns arranged adjacent to each other, it is possible to determine optical properties, such as the cut-off frequency, for the center of the image field and for other positions within the image field, such as for different image heights.

The visual inspection of the partial pattern has a disadvantage in that an impartial assertion of the optical properties of the lens system is difficult since the subjective judgment of the person performing the measurement is involved, and in that only simple optical properties, such as the cut-off frequency, can be determined.

There is an existing demand in objectively determining optical properties of lens systems, wherein the determined optical property may include optical properties which are more elaborate than the cut-off frequency.

### SUMMARY

The present invention has been made taking the above into consideration.

It is an object of the present invention to provide systems and methods for objectively determining optical properties of lens systems.

According to embodiments certain embodiments, a method of determining at least one optical property of a lens system comprises imaging of a test pattern into an image plane using the lens system, wherein the test pattern comprises a plurality of adjacent partial patterns and wherein different partial patterns include different identifiers.

According to some embodiments, each of the partial patterns is configured such that at least one optical property of the lens system can be determined for a defined image position based on the projected image of the partial pattern. For this purpose, the partial pattern may comprise one or more light-to-dark transitions. Such light-to-dark transitions can be implemented in different ways. For example, parallel light and dark strips, forming line pairs, can be positioned adjacent to each other. Further, configurations according to a checkerboard are possible. Herein, a partial pattern may comprise plural sub-partial patterns differing with respect to their line density and/or orientation of the line pairs. One example of a partial pattern includes sector-shaped stripes extending from a center. In such configuration, the line pair density continuously increases with increasing distance from the center, wherein different orientations of the line pairs are provided. Such configuration of a partial pattern is commonly referred to as a “Siemens star”.

According to exemplary embodiments, the different partial patterns have identical configurations as far as they provide light to dark transitions for the subsequent image analysis. According to other exemplary embodiments, the test pattern comprises partial patterns having different configurations.

The adjacent partial patterns are located at different positions within the image field of the lens system such that they differ at least with respect to their position within the image field. It is possible to determine a local optical property of the lens system from each of the projected partial patterns, wherein the local optical property corresponds to the position of the projected partial pattern within the image field. According to exemplary embodiments, the local optical property is associated with a position within the image field.

According to certain embodiments, the partial patterns of the test pattern each comprise an identifier, wherein the identifiers of different partial patterns are different.

According to exemplary embodiments, the identifiers include numbers or letters or other symbols implemented as light-to-dark transitions in the respective partial pattern. Identifiers implemented as numbers and letters may have an advantage in that they can be readily recognized by an inspecting person. Other suitable symbols may have an advantage in that they can be readily recognized by automated image processing.

According to an exemplary embodiment, each partial pattern comprises two types of identifiers, wherein one type of identifier can be readily recognized by a person while the other type of identifier can be readily recognized by automatic image processing.

According to certain embodiments, a method of determining at least one optical property of a lens system comprises positioning of a position sensitive detector in a region of an image plane of a projected test pattern such that a portion of the test pattern is simultaneously incident on the position sensitive detector. The portion of the test pattern includes at least one or more partial patterns of the test pattern, but not all partial patterns of the test pattern. For example, one, two, three or even more partial patterns are simultaneously incident on the position sensitive detector. However, not all partial patterns are simultaneously incident on the position sensitive detector. For example, less than 50%, less than 25% or even less than 10% of the partial patterns are simultaneously incident on the position sensitive detector. Since a projected image of a test pattern for an objective lens of a still picture camera may have an extension of one or more square meters, such embodiment has an advantage in that a position sensitive detector which is small compared to the projected test pattern can be used for determining the optical properties of the lens system. For this purpose, it can be sufficient that the position sensitive detector has a lateral extension such that only one of the partial patterns is incident on the detector.

According to certain embodiments, an image is recorded with the position sensitive detector when one or more complete partial pattern are simultaneously incident on the position sensitive detector. The recorded image is subsequently analyzed according to two aspects. According to one aspect, an identifier of the partial pattern contained in the image is identified. According to the other aspect, a property is determined based on the image of the partial pattern, wherein the determined property characterizes a local optical property of the lens system. At least one optical property of the lens system is determined for and associated with an image position of the lens system corresponding to the position of the partial pattern having the respective identifier within the test pattern. The at least one optical property of the lens system is determined based on the determined property and the identified identifier.

According to embodiments herein, this process is repeated for other partial patterns by displacing the position sensitive detector within the image plane such that respective other partial pattern are incident on the detector, wherein images are recorded and analyzed as illustrated above.

According to some embodiments, the position sensitive detector can be a hand-held device held in the image plane by the person performing the method. Herein, an exactly reproducible orientation of the detector relative to the image plane might not be assured.

According to exemplary embodiments, the analysis comprises determining of an orientation of a recorded image relative to the imaged test pattern and the image plane, respectively. For example, it is then possible to perform a rotation of the recorded image by software based on the determined orientation and to perform the analysis for determining the optical property based on the rotated image in order to reproducibly determine directional optical properties, such as a radial and a tangential MTF.

According to certain embodiments, a system for determining at least one optical property of a lens system comprises a position sensitive detector for generating image data representing an image projected onto the detector, and a controller configured to receive the image data, to perform a first analysis of the image data in order to determine an identifier of a partial pattern contained in the image represented by the image data, to perform a second analysis in order to determine at least one property based on the image of the partial pattern, and to generate data representing the at least one optical property of the lens system for an image position based on the determined at least one property and the determined identifier.

According to some embodiments, the system further comprises a light source, a test pattern and a mounting structure for the lens system configured such that the test pattern can be projected into an image plane with the light of the light source.

According to exemplary embodiments herein, the system further comprises a screen positioned in the image plane or in a region of the image plane, wherein the test pattern is projected onto the screen.

According to some embodiments herein, the system further comprises imaging optics configured such that the image projected onto the screen is imaged onto the position sensitive detector. According to exemplary embodiments herein, the imaging optics comprises a semi-transparent mirror which is traversed by a beam path for projecting the test pattern onto the screen and which folds a beam path imaging the projected pattern onto the position sensitive detector.

According to some embodiments, the position sensitive detector provides plural spectral channels such that the at least one optical property of the lens system can be determined for plural different colors. According to an example, the position sensitive detector comprises a CCD camera.

### BRIEF DESCRIPTION OF THE DRAWINGS

The forgoing as well as other advantageous features of the present disclosure will be more apparent from the following detailed description of exemplary embodiments with reference to the accompanying drawings. It is noted that not all possible embodiments necessarily exhibit each and every, or any, of the advantages identified herein.

FIG. 1 is a schematic illustration of a system for determining at least one optical property of a lens system;

FIG. 2 is a schematic illustration of a position sensitive detector of the system shown in FIG. 1;

FIG. 3 is a schematic illustration of a test pattern which can be used in the system shown in FIG. 1;

FIG. 4 is a schematic illustration of a partial pattern of the test pattern shown in FIG. 3;

FIG. 5 is a graph representing exemplary optical properties of a lens system determined based on an image of a partial pattern;

FIG. 6 is a flowchart illustrating a process of recording images of plural partial patterns in a method of determining at least one optical property of a lens system; and

FIG. 7 is a flowchart illustrating an analysis of images in a method of determining at least one optical property of a lens system.

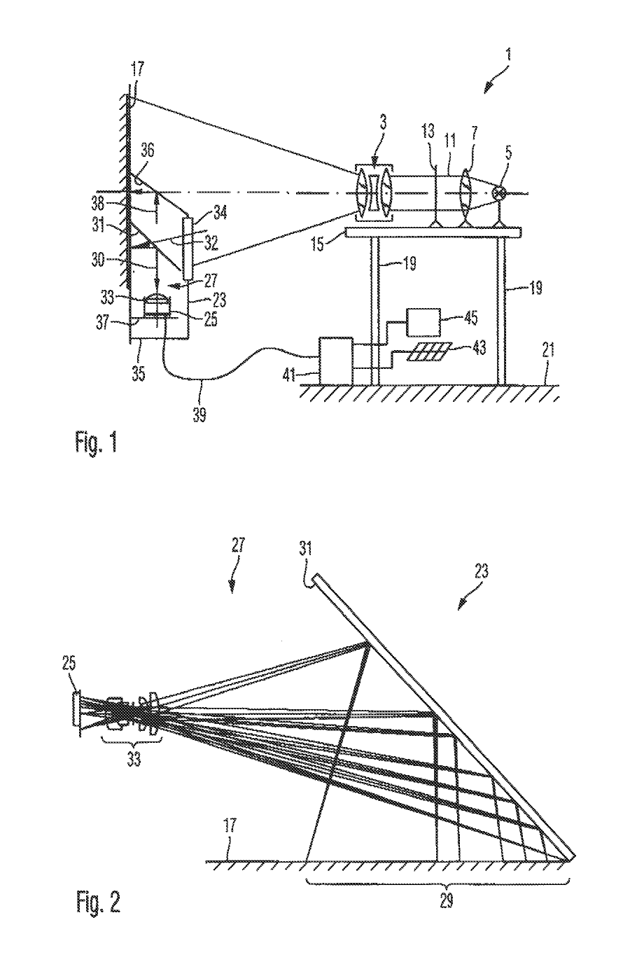

FIG. 1 is a simplified schematic illustration of a system 1 for determining optical properties of a lens system 3. The lens system 3 can be, for example, an objective lens for a still picture camera, an objective lens for a movie camera, an objective lens of a projector, or other lens, comprising plural lens elements. The plural lens elements can be displaceable relative to each other in order to adjust a focus position or magnification of an image produced by the lens system.

The system comprises a light source 5 for generating projection light, a condenser lens system 7, which may comprise plural lens elements, for forming a light beam 11 and directing the light beam onto a test pattern 13. The test pattern can be, for example, of a transparency slide type in which light transparent and non-transparent regions are provided on a carrier. The lens system 3 is mounted on a mounting structure 15 of the lens system 3 and positioned relative to the test pattern 13 such that the light beam 11 projects the test pattern through the lens system 3 onto a screen 17 positioned at a distance from the lens system 3. The mounting structure 15 for the lens system 3 may also provide a mount for the light source 5, the condenser lens system 7 and the test pattern 13 and can be supported for example by legs 19 on a floor 21 of a laboratory. The screen 13 can be provided, for example, by a wall of the laboratory or a separate screen, such as a pull-down screen.

A detection system 23 for portions of the test pattern 13 projected onto the screen 17 comprises a position sensitive detector 25 and optics 27 for imaging a portion of the screen 17 onto the position sensitive detector 25.

A detailed representation of the detection system 23 and of a beam path for imaging a portion 29 of the screen 17 onto the position sensitive detector 25 is schematically shown in FIG. 2. The optics 27 comprises a semi-transparent mirror 31 at which a beam path indicated by an arrow 30 in FIG. 1 and extending from a region 29 of the screen 17 to the position sensitive detector 25 is folded, and a lens system 33. Exemplary rays of the beam path are shown in FIG. 2. The position sensitive detector 25 is mounted on a board 37 mounted within a housing 35 of the detection system 23.

The semi-transparent mirror 31 is traversed by the beam path indicated by a arrow 32 in FIG. 1 and extending from the lens system 3 to the screen 17 for projecting the test pattern onto the screen. The housing comprises a window 34 traversed by the beam path 32 and allowing the light projecting the pattern to enter the housing and reach the screen 17. The housing may comprise a light absorbing inner surface for absorbing projection light 38 reflected from the semi-transparent mirror 31, such that stray light reaching the detector 25 is reduced. The surface 36 can be oriented such that projection light 38 reflected from the semi-transparent mirror 31 and not absorbed by the surface 36 is reflected from the surface 36 into a direction such that it does not reach the detector 25.

The lens system 33 is also mounted on the board 37. An exemplary combination of a board 37 having a position sensitive detector 25 and a lens system 33 is a product which can be obtained under the product designation “Macro Lens LD 0.16×” from IB/E Optics, 94116 Hutthurm, Germany. Interface circuitry of the position sensitive detector 25 provides control input and data output for the detector and can be connected via a cable 39 or some other data link, such as a wireless data link, to a controller 41. The controller 41 can be embodied as a computer and suitable software. Input media, such as a keyboard 34 and/or a mouse, and output media, such as a monitor 45 are connected to the controller 41 to allow operation by a user.

A person operating the system 1 may instruct, via the controller 41, the position sensitive detector 25 to record an image of a portion 29 of the test pattern 13 projected onto the screen 17, and to transmit corresponding image data to a controller 51. The controller 41 then performs an analysis of the image data as this will be illustrated in more detail below.

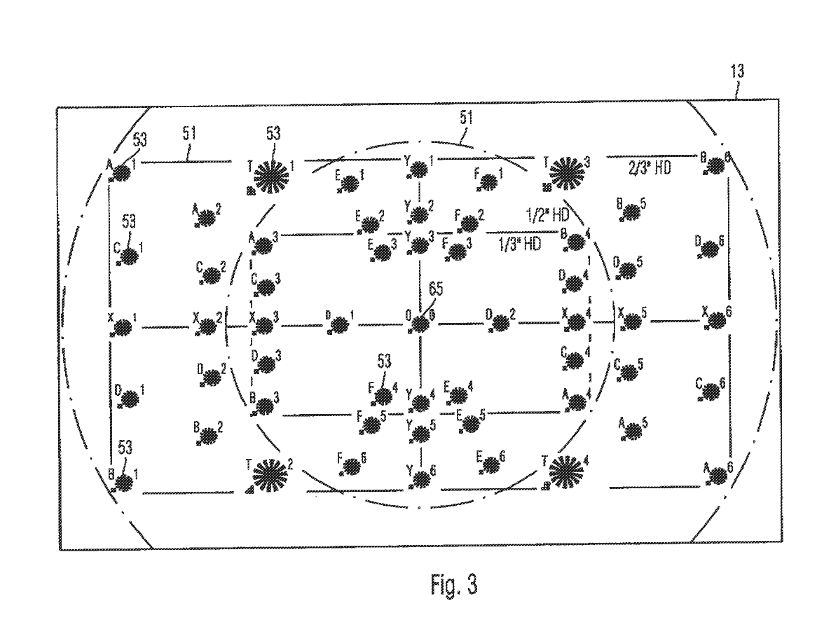

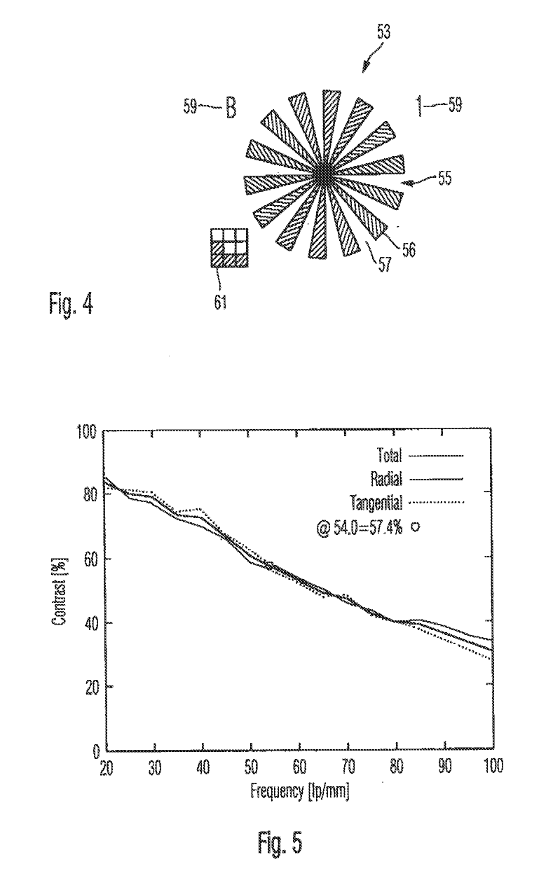

The test pattern 13 is shown in FIG. 3. Apart from some line-shaped marks 51, the test pattern comprises a plurality of partial patterns 53, wherein a partial pattern 53 positioned at the bottom left of FIG. 3 is magnified in FIG. 4. The partial pattern 53 shown in FIG. 4 comprises a line pattern 55 providing a plurality of light-to-dark transitions for analyzing optical properties. In particular, the pattern 55 comprises a plurality of sector-shaped black or non-transparent strips 56, and white or light-transparent strips 57 extending from a center.

The partial pattern 53 further comprises two types of identifiers: An identifier 59 which can be recognized by a person, and an identifier 61 suited to be identified by an automatic image processing. In the example shown in FIG. 4, the identifier 59 recognizable by a person comprises the letter “B” and the numeral “1”. The identifier 61 configured for automatic recognition comprises an array of nine points or pixels. 81 different identifiers can be represented with such type of identifier. It is apparent that the identifiers 59 and 61 shown in FIG. 4 are of an exemplary nature. Other systems for providing identifiers can be selected which may include other symbols than letters and numerals and also other combinations of symbols than the symbols provided by the nine points 61. In particular, the identifiers 59 configured to be readily recognized by a person are not necessary for performing the disclosed method. However, these identifiers make it easier for the person to perform the method. The symbols providing the identifier 61 configured for automatic recognition may also comprise letters and numerals. Moreover, it is possible to integrate the identifier 61 with the pattern 55 providing the light-to-dark transitions for analysis of the optical properties. For example, lengths of extension of the strips 56 from the center may vary such that the pattern 55 contains the information of the identifier 61 which can then be obtained by image analysis.

The pattern 55 shown in FIG. 4 has a shape of a star which is also referred to as a “Siemens star”. In the illustrated example, all partial patterns 53 have the shape of a star, wherein diameters of the stars can be different, as it is apparent from FIG. 3. However, the identifiers 61 of the partial patterns 53 are different for the partial patterns such that each partial pattern 53 of the test pattern 13 has a distinct identifier.

In order to determine at least one optical property of the lens system 3, the detection system 23 is positioned relative to the screen such that one of the partial patterns 53, such as, for example, the partial pattern shown at the bottom left in FIG. 3 and in more detail in FIG. 4 is imaged onto the position sensitive detector 25. The image detected by the detector 25 is transmitted to the controller 41, and the controller performs an image analysis. Herein, the star-shaped pattern 55 and the center thereof are identified within the recorded image. Intensity values of the image along circles about the center are determined. These intensity values will be modulated in a circumferential direction about the center. A modulation of the intensity values is determined. A contrast or a MTF-value corresponding to a radius of the circle can be determined from such modulation. A given radius of the circle within the image corresponds to a corresponding radius of the partial pattern 53 within the test pattern, and the line pairs have a predefined distance per millimeter at this radius. The MTF-value determined from the image can be associated with a line pair density, measured in lp/mm, in the test pattern. For example, MTF-values for 20, 40, 60, 80 and 100 lp/mm can be determined from the image of the pattern 55.

The identifier 61 is identified within the image of the partial pattern 53 and processed. Based on the determined identifier it is possible to determine the determined MTF-value of a position within the image and relative to the test pattern 13. Accordingly, it is possible to determine the MTF-value for a position corresponding to the position of the test pattern 53 which carries the identifier 59 “B1” readable by the user and positioned at the bottom left in the test pattern 13 (see FIG. 3).

Such determination can be performed for each of the plurality of test patterns 53 by repeating the procedure illustrated above. Herein, the detection system 23 is subsequently positioned relative to the screen 17 such that a next partial pattern 53 is imaged onto the detector 25.

FIG. 5 is an exemplary representation of a possible result of the determination of optical properties based on the pattern 55. The representation is a graph showing the MTF-value dependent on the spatial frequency, i.e. the line pair density in lp/mm. Herein, the MTF-value is shown for both a radial direction relative to the center 65 of the test pattern and a tangential direction relative to the center 65, while also the total MTF-value is shown as an average of the radial and tangential values. The radial and tangential values can be determined from the pattern 55 by using only those bright to dark transition for the analysis which extend in a radial direction relative to the center 65 of the test pattern 13 and in a direction orthogonal to this radial direction, respectively.

The camera 25 can be a color camera detecting light intensities in different spectral channels. This allows to determine the optical properties of the lens system 3 for one or more different spectral channels, since lenses typically show different optical properties for different colors.

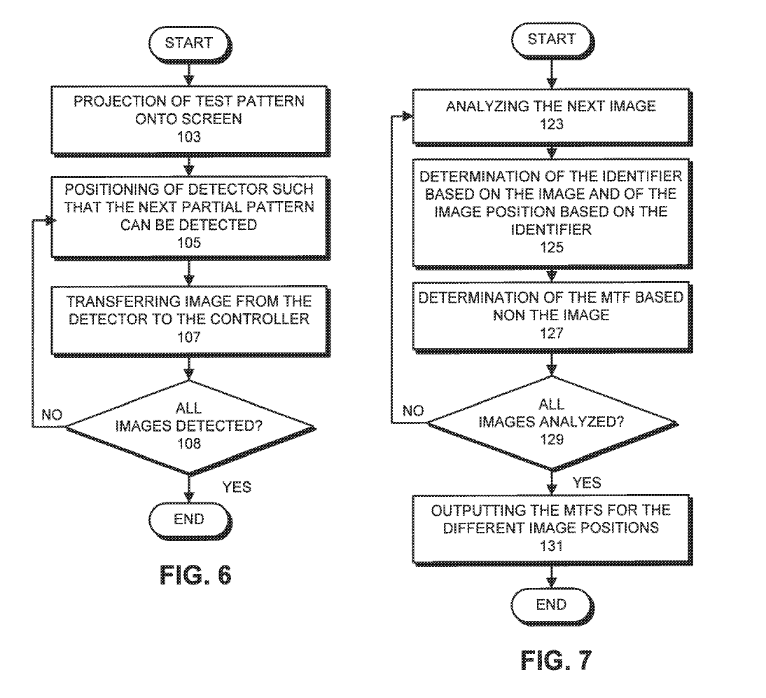

A method 101 for recording images of test patterns 53 will be illustrated with reference to the flowchart shown in FIG. 6 below. At first, the test pattern is projected onto the screen in a step 103. Thereafter, the detection system is positioned on the screen such that one of the partial patterns is imaged onto the position sensitive detector in a step 105. Data of the recorded image are transmitted to a controller in a step 107. In a step 109, it is determined whether all of those partial patterns for which an analysis is desired, are processed. If this is true, the method 101 for recording images is terminated. If not all partial patterns are processed, the method proceeds at step 105, and the detection system is positioned relative to the screen such that a next partial pattern is imaged onto the detector, and image data of the recorded image are subsequently transmitted to the controller 107 in a step 107.

A method 121 of analyzing the images recorded in the method 101 will be illustrated with reference to the flowchart shown in FIG. 7 below. A first image of the recorded images is analyzed in a step 123 by identifying the identifier of the partial pattern contained in the image in a step 125 and by determining the corresponding position within the image of the lens system based on the identifier, in a step 125. In a step 127, the optical property, which is, in the illustrated example, represented by MTF-values, is determined in a step 127 based on the image of the partial pattern.

The step 127 may include a processing for determining an orientation of the partial pattern within in the recorded image. It is then possible to rotate the image of the partial pattern based on the determined orientation before the directional optical properties of the lens system are determined. It then possible to record the images (steps 105 and 107 of FIG. 6) without accurately aligning the hand held detector along vertical or horizontal directions.

In a step 129, it is determined whether all images are analyzed. If this is not the case, the method continues at step 123, and a next image is analyzed. If all images are analyzed, an output of the results of the analysis is produced in a step 131, wherein such output may comprise storing of the results in a file, generating a representation on a monitor, or other types of output.

In the example illustrated above, the detection system comprises imaging optics configured to image portions of the test pattern projected onto the screen onto the position sensitive detector. Other types of detection of portions of the image of the test pattern generated in the image plane are possible. For example, the position sensitive detector can be positioned directly in the image plane in order to perform a position sensitive detection of a portion of the image of the test pattern. For this purpose, the light sensitive receiving surface of the position sensitive detector is oriented towards the objective lens projecting the test pattern, and the provision of a separate imaging optics can be omitted. Such direct detection is possible if the detection surface of the position sensitive detector has a sufficient size such that a partial pattern can be imaged onto the detection surface.

In the example illustrated above, the partial pattern has the shape of a star having bright and dark strips. It is, however, possible to provide other shapes of the partial patterns as long as it is possible to determine local optical properties of the lens system by image analysis of the image of the partial patterns.

While the invention has been described with respect to certain exemplary embodiments thereof, it is evident that many alternatives, modifications and variations will be apparent to those skilled in the art. Accordingly, the exemplary embodiments of the invention set forth herein are intended to be illustrative and not limiting in any way. Various changes may be made without departing from the spirit and scope of the present invention as defined in the following claims.

What is claimed is:

1. A method of determining at least one optical property of a lens system, the method comprising:
imaging a test pattern into an image plane using the lens system, wherein the test pattern comprises a plurality of adjacent partial patterns and wherein different partial patterns include different identifiers;
positioning a position sensitive detector in a region of the image plane such that a portion of the test pattern is imaged onto the position sensitive detector, wherein the portion of the test pattern consists of at least one partial pattern but not all of the plural partial patterns;
recording an image of the portion of the test pattern using the position sensitive detector;
performing a first analysis of the recorded image and determining the identifier of the at least one partial pattern contained in the image, and a second analysis of the image and determining at least one property based on the image of the at least one partial pattern contained in the image; and
determining the at least one optical property of the lens system for an image position of the lens system based on the determined at least one property and the determined identifier.

2. The method according to claim 1, wherein the positioning of the position sensitive detector, the recording of the image, the performing of the first analysis and the second analysis and the determining of the at least property of the lens system are repeated plural times by positioning the position sensitive detector at different locations within the region of the image plane, such that different partial patterns are incident on the position sensitive detector, and wherein the at least one optical property is determined for plural different image positions.

3. The method according to claim 1, wherein the performing of the first analysis and the second analysis comprise determining an orientation of the recorded image relative to the imaged test pattern, and wherein the at least one optical property is determined based on the determined orientation.

4. The method according to claim 1, wherein the at least one optical property comprises data representing a modulation transfer property of the lens arrangement.

5. A system for determining at least one optical property of a lens system, the system comprising:
a position sensitive detector for generating image data representing an image projected onto the detector, and
a controller configured to receive the image data, to perform a first analysis of the image data in order to determine an identifier of a partial pattern contained in the image represented by the image data, to perform a second analysis of the image data in order to determine at least one property based on the image of the partial pattern, and to generate data representing the at least one optical property of the lens system associated with an image position of the image based on the determined at least one property.

6. The system according to claim 5, further comprising a light source, a test pattern and a mounting structure for the lens system positioned such that the test pattern can be projected into an image plane with light of the light source.

7. The system according to claim 5, wherein the test pattern comprises a plurality of adjacent partial patterns, and wherein different partial patterns include different identifiers.

8. The system according to claim 5, wherein the partial pattern is configured such that at least one light-to-dark transition occurs in the projected image of the partial pattern.

9. The system according to claim 5, wherein the position sensitive detector is integrated with a handheld device.

10. The system according to claim 5, further comprising a screen positioned in the image plane, and imaging optics, wherein the screen and imaging optics are configured to image an image projected onto the screen onto the position sensitive detector.

11. The system according to claim 10, wherein the imaging optics comprises a semi-transparent mirror configured to fold a beam path between the screen and the position sensitive detector.

12. The system according to claim 5, wherein the position sensitive detector has a plurality of spectral channels.
